(19) United States
(12) Patent Application Publication
(10) Pub. No.: US 2011/0017915 A1
(43) Pub. Date: Jan. 27, 2011

(54) DRIFT SCANNER FOR RARE CELL DETECTION

(75) Inventor: Douglas N. Curry, San Mateo, CA (US)

Correspondence Address: FAY SHARPE LLP / XEROX - PARC, 1228 EUCLID AVENUE, 5TH FLOOR, THE HALLE BUILDING, CLEVELAND, OH, 44115, US

(73) Assignee: PALO ALTO RESEARCH CENTER INCORPORATED, Palo Alto, CA (US)

(21) Appl. No.: 12/508,263

(22) Filed: Jul. 23, 2009

(51) Int. Cl. G01N 23/00; G01T 1/16

(52) U.S. Cl. 250/362; 250/363.01

(57) ABSTRACT

A fluorescence microscope for rare cell detection includes a laser beam illumination source for generating a laser beam to illuminate a specimen. A laser beam shaper is configured to generate a flat top (or uniform) laser beam. A time delay integration (TDI) image acquisition system includes a movable stage to hold the specimen, and a bi-directional row shiftable CCD array of a CCD camera system. The movable stage and bi-directional row shiftable CCD array are synchronized to acquire an image of the specimen by TDI. A low resolution image conversion arrangement includes the bi-directional row-shiftable CCD array and a clock which controls operation of the bi-directional row-shiftable CCD array, whereby charge is combined and collected during a readout operation, resulting in a lower resolution, yet high speed, acquired image.

### BACKGROUND

The present application is directed to the imaging arts, and more particularly to the detection of rare cells in biological applications such as blood smears, biological assays and the like, and will be described with particular reference thereto.

With attention to the detection of cells, there are benefits to being able to scan large numbers of cells, such as in the range of 1-10 million cells, or even up to 50 million or more cells at a time. A system which can effectively and quickly scan large numbers of cells would be beneficial in many biological applications, such as an initial or pre-scan of cells to determine the existence of potential rare cells which may be only one in every million or so cells investigated. These rare cells are of interest as they may indicate the existence of various forms of cancer, or certain gene abnormalities, among other biological conditions.

In rare cell studies, a problem arises due to the concentration of rare cells in the blood or other bodily fluids being very low. In a typical rare cell study, blood or other bodily fluid is processed to remove cells that are not needed. Then a fluorescent material is applied that attaches to certain antibodies, which in turn selectively attach to a cell surface or cellular protein of the rare cells. The cellular proteins may be membrane proteins or proteins within a cell, such as cytoplasm proteins. The antibodies may also attach to other types of molecules of the rare cell, as well as to DNA.

The fluorescent material may be a fluorescent marker dye or any other suitable material which will identify the cells of interest. A smear treated in this manner, which may include the blood and/or components of the blood, is prepared and optically analyzed to identify rare cells of the targeted type. For statistical accuracy it is important to obtain as large a number of cells as required for a particular process, in some studies at least ten rare cells should be identified, requiring a sampling of at least ten million cells, and up to fifty million or more, for a one-in-one-million rare cell concentration. Such a blood smear typically occupies an area of about 100 cm². It is to be understood, however, that this is simply one example and other numbers of cells may be required for statistical accuracy for a particular test or study. Other cell identifiers which are being used and investigated are quantum dots and nano-particle probes. Also, while a rare cell is mentioned as a one-in-one-million cell concentration, this is not intended to be limiting and is only given as an example of the rarity of the cells being sought. The concepts discussed herein are to be understood to be useful in higher or lower levels of cell concentration.

Turning to research applications, the scanning of a large number of cells and the characterization of each of the scanned cells may also have substantial benefits. For example, a hundred different patches, each containing 10,000 cells, maybe generated where each patch will receive a different protocol or process. Thereafter it may be useful to determine how each cell on a specific patch is affected by the protocol or process which it has undergone. One procedure of achieving such detection would be to apply a fluorescent material, and to identify those cells to which the material has become attached either to the cell's surface, cellular proteins or other portions of the cell.

A particular area of research which may benefit from the present concepts includes HIV research, where it is known the virus enters into a cell causing the cell to produce the viral protein on its membrane. However, the produced viral protein exists in very small amounts, and therefore it is difficult to detect affected cells with existing technology.

A number of cell detection methods and processes have been proposed. These include various types of automated microscopic imaging, such as described by Bauer et al. in “Reliable and Sensitive Analysis of Occult Bone Marrow Metastases Using Automated Cellular Imaging,” Clinical Cancer Researcher, Vol. 6, 3552-3559, September 2000. By use of this technique, a scan rate of approximately 500,000 cells in eighteen minutes was obtained.

Another technique used for cell detection in the blood is the use of immunomagnetic cell enrichment in combination with digital microscopy. This technique is reported by Witzig et al. in “Detection of Circulating Cytokeratin-Positive Cells in the Blood of Breast Cancer Patients Using Immunomagnetic Enrichment and Digital Microscopy”, Clinical Cancer Researcher, Vol. 8, 1085-1091, May 2002.

A proposed cancer detection technique uses reverse transcriptase polymerase chain reaction (RT-PCR) with some immunomagnetic isolation. A discussion of such a technique is, for example, set forth in the article by Ghossein et al. entitled “Molecular Detection and Characterization of Circulating Tumour Cells and Micrometastases in Solid Tumours,” European Journal of Cancer, 36 (2000) 1681-1694. Another form of immunomagnetic detection is described by Flatmark et al. in the article, “Immunomagnetic Detection of Micrometastatic Cells in Bone Marrow of Colorectal Cancer Patients,” Clinical Cancer Researcher, Vol. 8, 444-449, February 2002.

Accurate quantification of disseminated tumor cells is proposed to be obtained by using a fluorescence image analysis as disclosed by Mehes et al. in the article entitled “Quantitative Analysis of Disseminated Tumor Cells in the Bone Marrow of Automated Fluorescence Image Analysis,” in Cytometry (Communications in Clinical Cytometry), 42:357-362 (2000). Another technique which enables a subsequent immunological characterization of isolated cells is obtained by the use of a immunomagnetic microbead isolation technique as discussed in the article by Werther et al., “The Use of the SELLection Kit™ in the Isolation of Carcinoma Cells from Mononuclear Cell Suppression,” Journal of Immunological Methods, 238 (2000) 133-141.

Burchill et al. provides a review and comparison of several detection methods in “Comparison of the RNA-amplification Based Methods RT-PCR and NASBA for the Detection of Circulating Tumour Cells,” British Journal of Cancer, (2002) 86, 102-109. Discussed are studies which suggest nucleic acid sequence-based amplification (NASBA) of targeted RNA may provide a robust manner of detecting cancer cells.

The above papers illustrate the wide range of research which is being undertaken in the rare of rare cell detection and identification. In this regard, the ability to scan large numbers of cells at a high rate is considered a key aspect which increases the throughput of the testing processes. The processes described in the cited papers set forth a variety of cell detection and location techniques. It is considered to be valuable to provide a system which improves the speed, reliability and processing costs which may be achieved by the systems or processes cited in the above papers.

A cell detection technique which is noted in more specific detail is fluorescence in situ hybridization (FISH). This process uses fluorescent molecules to paint genes or chromosomes. The technique is particularly useful for gene mapping and for identifying chromosomal abnormalities. In the FISH process, short sequences of single-stranded DNA, called probes, are prepared and which are complementary to the DNA sequences which are to be painted and examined. These probes hybridize, or bind, to a complementary DNA, and as they are labeled with a fluorescent tag, it permits a researcher to identify the location of sequences of the DNA. The FISH technique may be performed on non-dividing cells.

Another process of cell detection is flow cytometry (FC), which is a means of measuring certain physical and chemical characteristics of cells or particles as they travel in suspension past a sensing point. Ideally the cells travel past the sensing point one by one. However, significant obstacles exist to achieving this ideal performance, and in practice a statistically relevant number of cells are not detected due to the cells bunching or clumping together, making it not possible to identify each cell individually. In operation a light source emits light to collection optics, and electronics with a computer translates signals to data. Many flow cytometers have the ability to sort, or physically separate particles of interest, from a sample.

Another cytometry process is known as laser scanning cytometry (LSC). In this system, data is collected by rastering a laser beam within the limited field of view (FOV) of a microscope. With laser rastering, the excitation is intense and in a single wavelength, which permits a differentiation between dyes responsive at distinct wavelengths. This method provides equivalent data of a flow cytometer, but is a slide based system. It permits light scatter and fluorescence, but also records the position of each measurement. By this design, cells of interest can be relocated, visualized, restained, remeasured and photographed.

Another approach to imaging of biologic material is disclosed in U.S. Pat. No. 7,113,624, entitled “Imaging Apparatus And Method Employing A Large Linear Aperture”, to Curry, issued Sep. 26, 2006; and U.S. Pat. No. 7,277,569, entitled “Apparatus And Method For Detecting And Locating Rare Cells”, to Bruce et al., issued Oct. 2, 2007. These patents disclose an apparatus and method which locates rare cells in a sample. An imager stage supports the sample. A fiber optic bundle has a proximate bundle end of first fiber ends arranged to define an input aperture viewing the sample on the translation stage. The fiber optic bundle further has a distal bundle end of second fiber ends arranged to define an output aperture shaped differently from the input aperture and disposed away from the imager stage. A scanning radiation source is arranged and scans a radiation beam on a sample within a viewing area of the input aperture. The collected light information is transmitted via the fiber optic bundle to the output aperture, where a photodetector is arranged to detect a light signal at the distal bundle end. These concepts do not employ a device such as a fluorescence microscope for the initial pre-scan. The pre-scan acts to identify potential rare cells. Once these potential rare cells are identified, they are moved to a fluorescence microscope for further investigation. This requirement of a separate device for the low resolution pre-scan, and a movement of the potential rare cells to a higher resolution fluorescence microscope, has certain drawbacks.

The present application contemplates a new and improved apparatus and method for detecting rare cells which overcomes the above-referenced problems and others.

### BRIEF DESCRIPTION

A fluorescence microscope for rare cell detection includes a laser beam illumination source for generating a laser beam to illuminate a specimen. A laser beam shaper is configured to generate a flat top (or uniform) laser beam. A time delay integration (TDI) image acquisition system includes a movable stage to hold the specimen, and a bi-directional row shiftable CCD array of a CCD camera system. The movable stage and bi-directional row shiftable CCD array are synchronized to acquire an image of the specimen by TDI. A low resolution image conversion arrangement includes the bi-directional row-shiftable CCD array and a clock which controls operation of the bi-directional row-shiftable CCD array, whereby charge is combined and collected during a readout operation, resulting in a lower resolution, yet high speed, acquired image.

### BRIEF DESCRIPTION OF THE DRAWINGS

FIG. 1 is illustrates a fluorescence microscope rare cell detector according to the concepts of the present application;

FIG. 2 depicts a block diagram of various components and expanded views of various components of the fluorescence microscope rare cell detector of FIG. 1;

FIG. 3 depicts operation of TDI scanning and resulting charge accumulation of such scanning;

FIG. 4 correlates the movement of pixel charge and charge integration in a TDI operation.

FIG. 5 illustrates the transition of a Gaussian laser profile and a flat top laser profile occurring after passing through a laser shaper device;

FIG. 6 illustrates one simplified example of a lens arrangement to obtain a flat top or unified laser beam profile such as shown in FIG. 5;

FIG. 7 depicts a bi-directional row shiftable CCD array of the CCD array camera system

FIGS. 8A-8F depict a standard CCD readout sequence; and

FIGS. 9A-9F depicts a 2×2 binned pixel CCE readout sequence.

### DETAILED DESCRIPTION

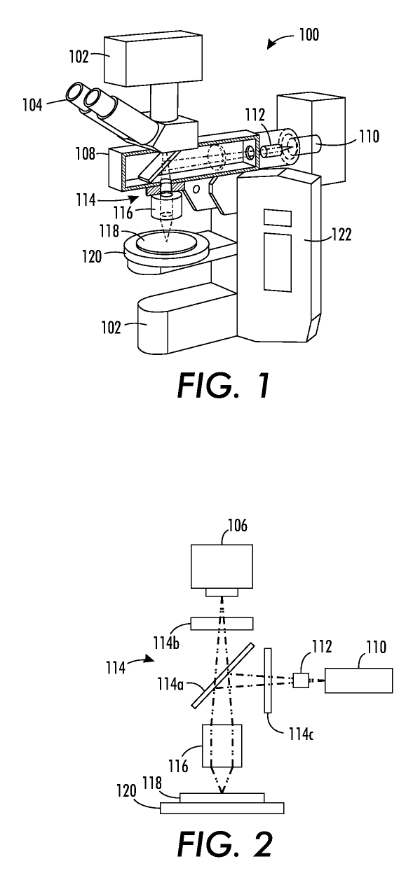

FIG. 1 illustrates a fluorescence microscope rare cell detector 100 having components and operating techniques allowing the microscope to act as a high-speed rare cell detector.

More particularly, fluorescence microscope rare cell detector 100 includes a base 102, which holds an eyepiece 104 that is coupled to a charge-coupled device (CCD) camera system 106. Two illumination sources, including an episcopic illuminator 108 and a light transmission source 110, which may be a laser. A beam shaper 112 is provided within the light source's path, and a filter cube 114 having a dichromatic mirror and filters is positioned to pass light to an objective 116, such that the shaped laser beam illuminates a specimen 118 held on a stage 120. A power source controller arrangement 122 provides power and control circuitry to control output from the illumination sources, as well as control movement of the stage, among other operations.

As mentioned initially, a concept of the present application is to reconfigure the physical structure and operation of existing fluorescence microscopes such that they are able to scan large numbers of cells in a short time period. Reconfiguration results in the fluorescence microscope acting as a rare cell detector, which does not generate images having as high an image resolution as existing fluorescence microscopes, but does provide sufficient resolution to identify potential rare cells of interest at a high speed. Among the alterations to fluorescence microscope rare cell detector 100 of FIG. 1 is the use of laser light source 110 shaped by beam shaper 112. Further changes to the configuration and operation includes using drift scanning (or time delay integration (TDI)) techniques for image acquisition. Particularly, TDI image acquisition is accomplished by proper control and operation of stage 118 holding specimen 120, and CCD camera system 106. Another aspect by which the fluorescence microscope is altered is through the use of bi-directional scanning of the CCD camera system. Particularly, a bi-directional row-shiftable CCD array is employed to efficiently enable time delay integration (TDI) instead of less efficient step-and-repeat methods. Still a further alteration to existing fluorescence microscopes is provision of a low resolution conversion of the acquired image data. Particularly, one of the most time critical operations of the scanning process is the A-to-D conversion step. The present system is designed to lower the number of A-to-D conversions necessary, to thereby increase the speed at which images are generated.

The individual alterations described above, each of which will be described in more detail below, combine to improve the speed at which biological cell investigations can be achieved to the fluorescence microscope rare cell detector of the present application.

Turning to FIG. 2, provided is a diagram illustrating various aspects of fluorescence microscope rare cell detector 100 of FIG. 1. Particularly, FIG. 2 more specifically shows beam shaper 112 in the path of the laser beam generated by laser 110, and the interaction of the resulting shaped laser beam with filter cube 114. As the expanded view of this figure shows, filter cube 114 includes dichromatic mirror 114a, emission filter 114b and exciter filter 114c. This Figure emphasized operation of dichromatic mirror 114a in a fluorescence microscope.

A distinction between the dichromatic mirror and standard interface filter is that dichromatic mirror 114a is specifically designed for reflection and transmission at defined boundary wavelengths, and operates at a 45° angle with respect to the microscope and illuminator optical axes. Dichromatic mirrors are configured with an interface coating which faces the excitation light source in order to reflect short excitation wavelengths at a 90° angle through the optical train to the specimen. This same dichromatic mirror also acts as a transmission filter to pass long wavelength fluorescence emissions from the objective to the image plane. As the wavelength transmission region between almost total reflection and maximum transmission is often limited to only 20 to 30 nanometers, the dichromatic mirror is able to precisely discriminate between excitation and emission wavelengths. The excitation filter 114c acts to select a narrow band of wavelengths from the wide spectrum generated by the lamp (i.e., laser) and then passes them to the dichromatic mirror, which in turn reflects the light through the objective onto the specimen.

Fluorescence emission gathered by the objectives passes once again through the dichromatic mirror 114a and the emission or barrier filter 114c before forming an image on the CCD camera system 106. Thus, light emitted from laser 110 passes through beam shaping element 112 (which will be discussed in detail below), and then passes through exciter filter 114c of filter cube 114. This shaped beam intersects dichromatic mirror 114a, and moves to objective 116 and impinges on sample 118. At this point, fluorescence light in the form of a beam is emitted from sample 118 and passes through emission filter 114b onto CCD camera 106.

Expanding on a first aspect of the altered fluorescence microscope operation is the implementation of drift scanning (also called herein time delay integration (TDI)) image acquisition. Time delay integration (TDI) is an imaging process in which a framed transfer image sensor produces a continuous image of a moving two-dimensional object or, in this case, specimen. The translation of the specimen is synchronized with the vertical charge transfer of each pixel on the CCD. This process offers on-the-fly integration of signal intensity of a moving object. By altering the speed of image motion and the related charge transfer, total integration time can be regulated. In addition, by providing more or less pixels in a vertical direction, total integration time can be adjusted at a fixed specimen speed.

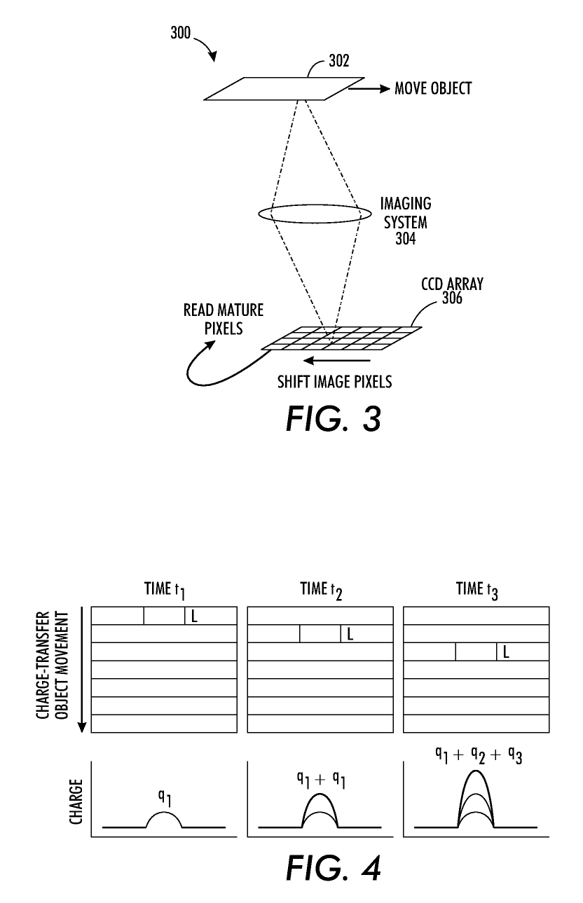

FIG. 3 illustrates the concept of TDI image acquisition 300, wherein an object, such as a microscope slide 302 with attached rare cancer cells is moved horizontally in the focus plane of an imaging system. A CCD array 306 in the image plane integrates the light from the moving object. As the image is translated across the face of the CCD array 306, rows of CCD pixels are shifted across the array face at the same rate and direction that the image moves, allowing the light to be integrated in synchronicity with its respective image pixels. As mature pixels are generated and shifted off the edge of the array, they are read by an analog to digital converter and transferred to computer memory.

Turning to FIG. 4, the movement of the pixel data and the charge accumulation are shown in correspondence. Consider time point t₁ at which the image of line L of the object to be imaged is focused on the first row of the CCD pixels. Charge q₁ corresponding to the light intensity of line L is collected in the first row of pixels during the scanning of this line. At time point t₂, the image of line L is captured by the second row of pixels, thus generating in this row charge q₂ corresponding to the light intensity of L. This newly generated charge is integrated with charge q₁ collected at time t₁ and shifted from the first row of pixels. The integrated charge is equal to q₁+q₂. At the same time, the image of the next line of the object (not shown) will be focused on the first row of CCD pixels.

The image intensity of line L increases as newly generated charges are added to existing charges. This operation will continue until the TDI scanning sequence is complete, and the integrated charge that represents line L is clocked off to the horizontal readout register. Then this integrated signal is quickly-within the scan time of one line-shifted off to the output amplifier.

Assuming the speed of the moving object is V (m/s) and the pixel size is d (μm). Then the vertical shift (scan) frequency is f=V/d^{(MHZ)}. If the scan rate of the detector is matched with the velocity of the moving object being imaged, the image will not blur.

For a M-stage TDI-CCD imager, where M is the number of CCD rows, the TDI integration time will be M times longer than the exposure time of one line. Therefore, the signal charge collected for the duration of the vertical shift will also increase by factor M. Accordingly, shot noise will increase by the square root of M, resulting in a theoretical signal-to-noise ratio improvement of the square root of M as well.

The practical limit on the number of TDI stages is determined by the accuracy of synchronization between the vertical-shift frequency and the velocity of the moving object

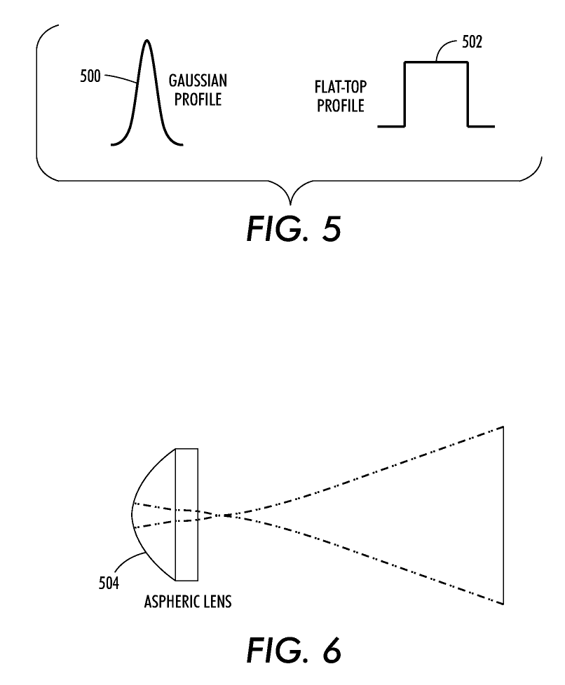

Another aspect of a device of the present application such as shown in FIGS. 1 and 2 is the use of beam shaper 112. In fluorescence microscope rare cell detector 100 of the present application, in place of an illumination source such as a mercury lamp which floods the object with weak filtered light, the present application employs a shaped laser beam. Particularly, the shaped laser beam at high power is used to precisely target only the portion of the object or sample corresponding to the CCD array. Thus, as shown in FIG. 5, the normal Gaussian illumination profile 500 of an output laser beam passes through beam shaper 112 whereby the Gaussian illumination profile of the laser beam is converted to a uniform profile, resulting in this embodiment a flat-top (or rectangular or square) output beam 502 which corresponds to the pixel area of the CCD array. There are several types of optical systems which may accomplish this transformation, including refractive, diffractive, beam integrators or a combination thereof. The choice of a suitable solution depends on power level, wavelength, quality of beam homogenization and other features of a particular task. Beam shapers are on the market, and one is known as the πShaper, which is family of refractive beam shaping systems intended to work with UV, visible and IR lasers (πShaper is a trademark of Moltech GmbH, Berlin, Germany). Another beam shaper on the market for producing flat-top or square beams is known as Flat-Top² Generator (Flat-Top² is a trademark of StockerYale, Inc. of Salem, N.H., United States of America).

FIG. 6 depicts a one-dimensional Gaussian to flat-top generator using a single lens 502. This of course is simply one example of how to generate a square wave output. By using multiple cross-cylinder lenses, the refractive optics can be designed to change a circular Gaussian shape to a rectangular flat-top shape that exactly matches that of the CCD array. The uniform profile and precise shape allows illumination by more than 80 to 90% of the available light from the laser.

The optics in the form of beam shaper 112 and the CCD array of camera 106 are integrated into fluorescence microscope rare cell detector 100. Thus, by this construction, and as previously mentioned, the laser beam operated on by beam shaper 112 provides illumination through the exciter filter 114c designed to pass the laser frequencies and to block stray light. The dichromatic mirror 114a with reflection band corresponding to the laser frequency placed at 45° in the path reflects the light into microscope objective 116. A fluorescence response is stimulated and a return Stokes-shifted signal is transmitted through dichromatic mirror 114a and emission filter 114b, and is imaged onto the CCD camera system 106.

A further aspect used to increase the throughput of fluorescence microscope rare cell detector system 100 is the implementation of bidirectional scanning.

Presently, detectors used in fluorescence microscopes are solid state detectors which consist of a dense matrix of photodiodes incorporating charged storage regions. Several variations on the basic concept are commercially available, including the popular charge-coupled device (CCD), the charge-injection device (CID), and the complementary-metal-oxide-semiconductor detector (CMOS). In each of these detectors, a silicon diode photosensor (often denoted in a pixel) is coupled to a charge storage region that is, in turn, connected to an amplifier that reads out the quantity of accumulated charge. In the CID and CMOS detectors, each individual photosensor has an amplifier associated with it, and the combined signals from a row of amplifiers is output in parallel. In a CCD, there is typically an amplifier at the corner of the array, and the storage charge is sequentially transferred through the parallel registers to a linear serial register, and then to an output node adjacent to the readout amplifier.

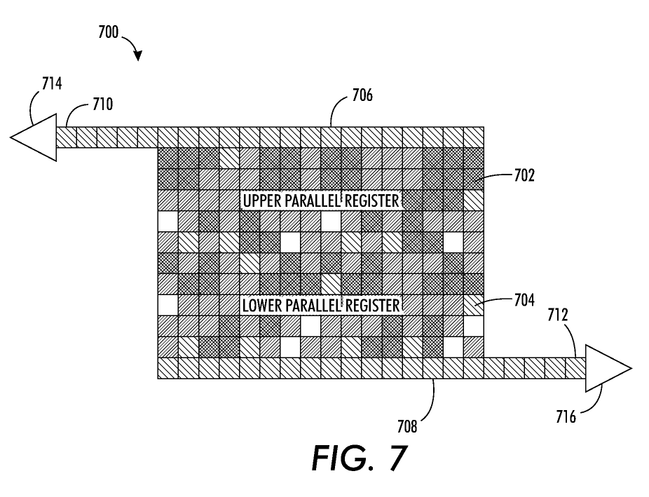

FIG. 7 illustrates a full-frame bi-directional row-shiftable CCD arrangement 700 designed to achieve high frame rates by use of a split parallel register (upper parallel register 702 and lower parallel register 704) that can be clocked to transfer charge in two directions toward dual serial registers (upper serial register 706 and lower serial register 708), each having separate output nodes (upper output node 710 and lower output node 712) and output amplifiers (upper amplifier 714 and lower amplifier 716). The frame rate of the sensor can be approximately doubled by this transfer scheme.

Readout rate is determined by the time required to digitize a single pixel (the serial conversion time) and is understood to be the inverse of that value. As the conversion time for a single pixel is considerably less than one second, the rate is often stated as a frequency (hertz, Hz), and sometimes referred to as pixel clock rate or simply clock rate. The frame rate of an imaging system incorporates the exposure time and extends the single pixel readout rate to the entire pixel array. It is defined as the inverse of the time required to acquire an image and to completely read the image data out to the amplifier. This variable is typically stated in frames per second (fps) or in frequency units (Hz). An approximation of frame rate is obtained by taking the inverse of the sum of total pixel digitization time and the exposure (integration) time, as follows:

Approximate Frame Rate(fps)=1/[(Nₚᵢₓₑₗ/t_{read})+Tₑₓₚ]

where N(pixel) is the number of sensor pixels being read, and t(read) and T(exp) represent the single-pixel read time and exposure time, respectively. In the equation, the total pixel digitization time for the array is represented by the quotient of the total pixel number divided by the single pixel read time (N(pixel)/t(read)).

Although this simplified expression for calculating frame rate is useful for certain comparison purposes, it omits a variety of other factors that affect the true frame rate achieved in practice, among them the operation mode of the CCD and the required exposure duration relative to frame read time in a given application. The details of the charge collection and transfer mechanisms employed by a particular sensor design, as well as the choice of operation modes, such as binning and reduced-array scanning, are significant in determining the actual imaging frame rate. Furthermore, it is implicit that absolute maximum frame rate is achieved at the expense of exposure duration, and a long exposure time relative to the time required to read out the accumulated charge becomes the limiting factor in such circumstances.

The true frame rate value is determined by the combined frame acquisition time and frame read time, each of which depends upon operational details specific to the camera system and application. Quantitatively the frame rate is therefore the inverse of the sum of these two variables, as expressed by the following equation:

Frame Rate(fps)=1/(Frame Acquisition Time+Frame Read Time)

Following the data acquisition stage, readout of collected charge occurs through one of several different transfer sequences, depending upon the CCD architecture. In the case of a full-frame device, readout takes place by shifting pixel rows directly from the parallel register into the serial register for transfer to the output amplifier. The frame-transfer CCD differs in that following signal integration, data from the entire image array is shifted to a storage array by simultaneously clocking the two sections in parallel, followed by single-row shifts of data in the store section into the serial register. The shift from the image to the storage array takes place rapidly, and while the storage array is being read out, the image array is available to integrate charge for the next frame. Consequently, the transfer from integration to the storage section is typically not significant in the frame read time determination for frame-transfer devices.

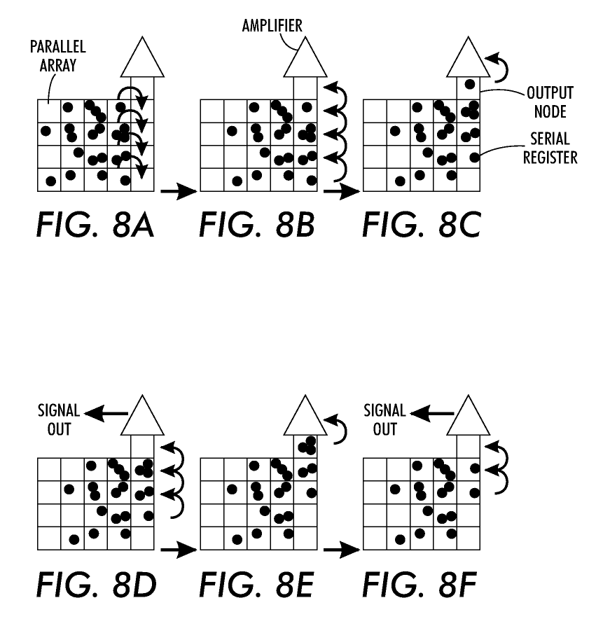

It is noted the normal mode of CCD readout is to shift one pixel row into the serial register, then to read each charge packet in that row by performing a series of column shifts in the register, with each pixel's charge being read as it advances to the output node and is collected for amplification and processing. When the entire serial register has been read out by alternating column shifts and pixel read cycles, another parallel shift cycle moves the next row from the array into the serial register. This process is repeated until all charge is shifted out of the parallel register. The major component of the frame read time is the pixel read time, or serial conversion time, which is multiplied by the total number of pixels being read from the image array. FIGS. 8A-8F represents diagrammatically the normal sequence of accumulating, transferring, and reading out charge from a full-frame CCD.

Illustrated in FIG. 8A is a truncated parallel CCD pixel array (4×4) that has been exposed to light in order to accumulate a charge pattern of photoelectrons (represented by spheres). Charge in the parallel register is shifted by one row from FIG. 8A to FIG. 8B, with the edge row of photoelectrons from the parallel register being transferred into the serial register. In FIG. 8C the first pixel in the serial register is shifted into the output node before being transferred to the amplifier (FIG. 8D) and output for processing. Substantively, simultaneously in FIG. 8D, the charges in the serial register are shifted toward the output node by one pixel. The next charge in the serial register is shifted from the output node to the amplifier in FIG. 8E, and the other charges in the serial register are again shifted toward the output by one pixel in FIG. 8F. This sequence is repeated until the entire charge pattern is transferred from the parallel array through the serial register to the amplifier.

The above description of course, when used in a bi-directional shifting register, would include the shifting and transferring in two directions, as opposed to a single direction as shown in this discussion for simplicity.

Pixel binning is another mechanism, previously mentioned, that is utilized to reduce image readout time and increase frame rate in CCD imaging, and is performed in the same manner as subarray display, by programmed variations in clock cycle sequences that control the transfer and digitization of sensor-generated charge packets. The technique of binning combines charge from adjacent pixels during the readout process, thereby improving signal-to-noise ratio and dynamic range of the system. Although an effectively larger pixel size lowers spatial resolution, the reduced number of charge packets to be transferred and digitized allows increased readout speed in conjunction with the improved signal level.

Both parallel and serial binning are possible, and in similarity to reduced-array readout, a charge integration period is performed, but the subsequent clocking sequences for charge transfer and pixel readout differ from those normally programmed. Parallel binning is performed during the readout cycle by clocking two or more parallel transfers into the serial register while holding the serial clocks fixed. The effect is to sum pixel charge from multiple rows into each serial pixel before the serial shift cycle begins. The serial binning process transfers two or more charge packets from the serial register into the CCD output node before the charge is read out.

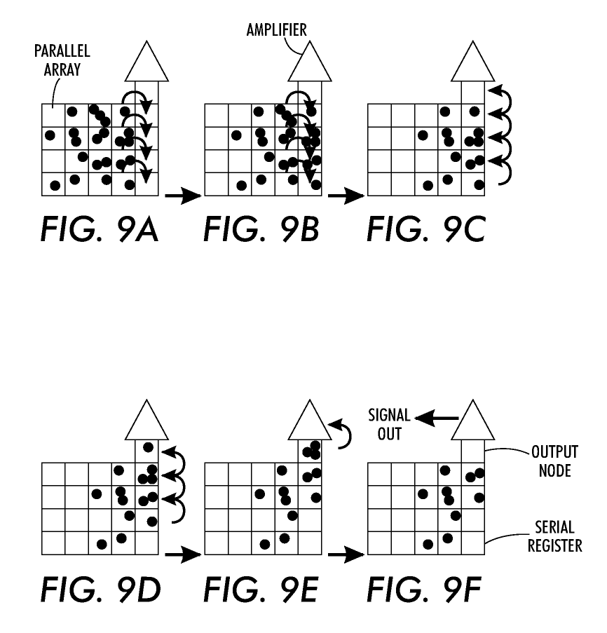

FIGS. 9A-9F present one example of a binned readout sequence, in which charge from two parallel transfers is summed in the serial register, followed by summing of two serial pixels into the output node for readout. Each readout cycle thus contains the charge from four adjacent pixels.

Various degrees of pixel binning can be utilized, and this is indicated by specifying the number of pixels being combined in the parallel and serial shift directions (termed binning factor, with a value of 1 indicating no binning). For example, a 3×3 binning factor specifies that three charge packets are summed into each well of the serial register by parallel shift repetitions, followed by three serial shift repetitions for each cycle of charge readout. Thus, for 3×3 binning, each charge packet digitized for image display or quantitative analysis represents nine adjacent pixels of the CCD array. Practically, any combination of parallel and serial binning factors may be programmed as a readout node provided that the sum of charge from the binned pixels does not exceed the full well capacity of the device. In order to accommodate charge summing and to maintain charge transfer efficiency, pixels in the serial register are typically designed to have higher well capacity than those in the parallel register. With regard to the effect of binning on the frame read time, parallel shift and serial conversion times are not affected, and the increased readout speed results simply from the reduction in the number of charge packets (combined pixels) subject to processing through the readout node.

The above teachings thus disclose concepts and arrangements which allow a fluorescence microscope to operate in a mode where the device acts as a fluorescence microscope operating in a low resolution imaging device mode for rare cell detection. As mentioned, one of the above aspects include implementation of drift scanning (i.e., TDI image accumulation), wherein an object such as a microscope slide with attached rare cell is moved horizontally in the focus plane of an imaging system. A CCD array in the image plane integrates the light from the moving object. As the image is translated across the face of the CCD array, rows of CCD pixels are shifted across the array face at the same rate and direction the image moves, allowing the light to be integrated in synchronicity with its respective image pixels. It is noted a back-thinned CCD array which benefits from an increased quantum efficiency may be used in this implementation.

Quantum efficiency is a measure of how well a specific sensor responds to different wavelengths of light. The higher the quantum efficiency, the more sensitive a CCD will be at a particular wavelength. Spectral response is a CCD characteristic that represents the relation between quantum efficiency and wavelength. Depending on a required spectral response, CCD sensors can be designed for front or back illumination.

In front-illuminated CCDs, light must pass through the polysilicon gate structure located above the photosensitive silicon layer called the “depletion layer.” However, variations in the indices of refraction between the polysilicon and the silicon cause shorter-wavelength light to reflect off the CCD surface. This effect combined with intense ultraviolet (UV) light absorption in polysilicon leads to diminished QE for those wavelengths in the front-illuminated detectors.

To improve the overall QE and enable increased CCD sensitivity, back-thinned technology can be used. In back-thinned devices, also known as back-illuminated CCDs, the incident photon flux does not have to penetrate the polysilicon gates and is absorbed directly into the silicon pixels.

A second aspect of the above teaching is the use of a shaped laser illumination. Particularly, a Gaussian illumination profile of a laser used as the illumination light source for the fluorescence microscope used as a rare cell detector is converted to a uniform profile by beam shaping optics. In one embodiment, the uniform profile is a flat top, square or rectangular wave generated laser beam. The uniform shape is designed to substantially match that of the pixels of the CCD array. The uniform profile and precise shape allows illumination by more than 80 to 90% of the available light from the laser.

A third aspect described herein is bidirectional scanning which shows that by using a bidirectional row-shiftable CCD array, it is possible to integrate time-delay integration (TDI) instead of less efficient step-and-repeat methods. The rectangular laser spot (generated by the shaped laser device), and the projected image CCD chip in the object plane are about 2 mm square. After a scan that moves the stage under the objective, the stage will either return to the next scan near the beginning position, or as in bidirectional scanning capability, move 2 mm to an adjacent scan position and translate backwards for the next scan. Thus bidirectional scanning can increase scanning efficiency from what might have been 50% to over 90%.

A further described feature is lowering the output resolution of the microscope to increase the speed of the system. This may be accomplished by use of a coarse CCD array or by use of binning operations. The use of the binning operations on the CCD allows for the low resolution conversion. Particularly, one of the most critical operations of the scanning process is the A-to-D conversion step. Each conversion produces noise and consumes time. In order to keep the number of A-to-D conversions to a minimum, a CCD chip with low resolution is needed to match the low resolution required to find rare cells. Most CCD chips are designed for high resolution by packing small pixels on the face of the CCD array. However, the rare cell detection method of the present application can utilize coarser pixels, since it is not necessary at this early scanning step to identify details of the cancer cells, but only the presence or absence of the proper light frequency which may indicate potential rare cells of interest. These coarse pixels are created by patterning large pixels rays on the face, or by combining smaller pixels together (i.e., binning) during the final shift-out process in the CCD array before the A-to-D conversion step. By implementing the above techniques and apparatus into an existing fluorescence microscope, a rare cell detection mechanism is created which allows an initial identification of potential cancer cells or other rare cells of interest. Then the mode of the fluorescence microscope may be switched back to obtaining of high resolution images to further investigate those images determined to be of interest by using the device as a regular fluorescence microscope.

Based on the foregoing discussion, in one embodiment the rare cell detection using the CCD-based pre-scan camera system would operate at 4× magnification and 8 micron resolution and require one 30-second pass for each desired fluorescent color. A subsequent image capture pass would use a step and repeat camera operating at 40× magnification to capture the candidate hit events. The system 100 would:

1. Enable single-instrument cancer screening;

2. Offer pre-scans at 2, 4 or 8 micron resolutions;

3. Improve pre-scan sensitivity over some existing systems;

4. Eliminate jitter, image warping and registration calibration;

5. Allow focus prediction during the capture pass;

6. Permit smaller 40× images for reduced file size;

7. Make possible fully automated pre-scan and capture operation;

Chart A shows the sampling arrangement for a compatible CCD scanner according to the present application. Under sampling with 4×4 binning on the CCD chip was used to produce 8 micron pixels. By adjusting the binning parameter from 4×4 to 2×2 or 1×1 the sampling resolution can be increased to 4 or 2 microns, respectively. Rows 1, 2, and 3 of the chart show the time, power, resolution, and other parameters required to operate with a 4× objective.

CHART A
DRIFT SCANNING CHARACTERISTICS

| | | | | | | | Resulting Resolution, FOV & Data Rate | | | | | |
|---|---|---|---|---|---|---|---|---|---|---|---|---|
| Time, Power & CCD Binning | | | | | | | sampl | CCD FOV | | element | data | file |
| CCD | | | CCD pixels | | TIME | PWR | res | (μm) | | size at | rate | size |
| Binning | Mag | NA | fast | slow | (sec) | (mW) | (μm) | fast | slow | field | (mhz) | GByte |
| 1 × 1 | 4x | 0.1 | 128 | 2048 | 180 | 29 | 2.0 | 256 | 4096 | 8.0 | 10.1 | 1.677 |
| 2 × 2 | 4x | 0.1 | 128 | 2048 | 100 | 14 | 4.0 | 256 | 4096 | 8.0 | 4.8 | 0.419 |
| 4 × 4 | 4x | 0.1 | 128 | 2048 | 35 | 14 | 8.0 | 256 | 4096 | 8.0 | 4.8 | 0.105 |

Light capture at low resolution/large field suffers mostly from lower numerical aperture. There is also a further penalty for sampling at higher resolutions when binning is increased from 4×4 samples per pixel to its most aggressive value of 1×1 samples per pixel. Additional light loss occurs at the edges of the illumination area (approximately 1.25 loss factor). The chart below is an extension of the above chart and shows this “loss product” on the left side corresponding to the three binning rates of Chart A.

To compensate for light loss, light gain factors are employed and shown on the right side of Chart B. These factors are increased laser power, faster scan time, improved scan efficiency, and higher detector quantum efficiency (provided by a back-thinned CCD). For example, increasing the laser power from (approx.) 2 to 14 mW gives the 6.8 value for power factor in the second and third rows. Increasing the quantum efficiency from 13% in the PMT to 85% in the CCD provides the 6.2 gain factor shown in the quantum efficiency column. The results show approximate cancellation of the loss products by these gain products for each binning rate.

CHART B

| | Light Loss Factors | | | | Light Gain Factors | | | | |
|---|---|---|---|---|---|---|---|---|---|
| CCD | NA | pixel | illum. | LOSS | pwr | time | scan | quantum | GAIN |
| Binning | factor | factor | couple | PRODUCT | factor | factor | eff | eff | PRODUCT |
| 1 × 1 | 43.6 | 16 | 1.25 | 871 | 14 | 5.1 | 1.9 | 6.2 | 871 |
| 2 × 2 | 43.6 | 4 | 1.25 | 218 | 6.8 | 2.9 | 1.8 | 6.2 | 218 |
| 4 × 4 | 43.6 | 1 | 1.25 | 54 | 6.8 | 1.0 | 1.3 | 6.2 | 54 |

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A fluorescence microscope for rare cell detection comprising:
a laser beam illumination source for generating a laser beam to illuminate a specimen to be investigated;
a laser beam shaper, configured to generate a uniform laser beam from the laser beam generated by the laser beam illumination source;
a time delay integration (TDI) image acquisition system including a movable stage designed to hold the specimen to be investigated and a bi-directional row-shiftable CCD array of a CCD camera system, wherein the movable stage and the bi-directional row-shiftable CCD array are synchronized in their operation to acquire an image of the specimen to be investigated by time delay integration; and
a low resolution image conversion arrangement which includes the bi-directional row-shiftable CCD array and a clock which controls operation of the CCD array, wherein the CCD array and the clock are configured to combine charge collected by adjacent pixels during a readout operation.

2. The fluorescence microscope for rare cell detector of claim 1, wherein the bi-directional row-shiftable CCD array is a back-thinned CCD array.

3. The fluorescence microscope for rare cell detector of claim 1, wherein the uniform laser beam is one of a laser beam having a flat-top, square or rectangular profile.

4. The fluorescence microscope for rare cell detector of claim 1, wherein the uniform laser beam is sized to match a portion of the sample corresponding to the CCD array.

5. The fluorescence microscope for rare cell detector of claim 1, further including an eyepiece.

6. The fluorescence microscope for rare cell detector of claim 1, wherein over 80% of available light of the shaped beam is used for illumination.

7. The fluorescence microscope for rare cell detector of claim 1, wherein the shaped uniform laser beam and a projected image on the CCD array in an object plane is approximately 2 mm square.

8. A method of rare cell detection comprising:
preparing a specimen to be investigated by fluorescence detection by fluorescent imaging by a fluorescence microscope configured for rare cell detection;
placing the specimen onto a movable stage of the fluorescence microscope;
generating a laser beam to illuminate the specimen to be investigated by a laser beam illumination source;
generating, by a laser beam shaper, a uniform laser beam from the laser beam generated by the laser beam illumination source;
performing a time delay integration (TDI) image acquisition of the specimen to be investigated by synchronously moving a movable stage designed to hold the specimen to be investigated and a bi-directional row-shiftable CCD array of a CCD camera system; and
outputting a low resolution image by controlling operation of the bi-directional row-shiftable CCD array with a clock which controls operation of the bi-directional row-shiftable CCD array of a CCD camera system, wherein operation of the clock causes the bi-directional row-shiftable CCD array to combine charge collected by adjacent pixels during a readout operation.

9. The fluorescence microscope for rare cell detector of claim 8, wherein the bi-directional row-shiftable CCD array is a back-thinned CCD array.

10. The fluorescence microscope for rare cell detector of claim 8, wherein the uniform laser beam is one of a laser beam having a flat-top, square or rectangular profile.

11. The fluorescence microscope for rare cell detector of claim 8, wherein the uniform laser beam is sized to match a portion of the sample corresponding to the CCD array.

12. The fluorescence microscope for rare cell detector of claim 8, wherein the low resolution image conversion arrangement is a binning arrangement wherein at least two or more pixel charges are combined during a readout operation.

13. The fluorescence microscope for rare cell detector of claim 8, wherein over 80% of available light of the shaped beam is used for illumination.

14. The fluorescence microscope for rare cell detector of claim 8, wherein the shaped uniform laser beam and a projected image on the CCD array in an object plane is approximately 2 mm square.

15. A fluorescence microscope for rare cell detection comprising:
a laser beam illumination source for generating a laser beam to illuminate a specimen to be investigated;
a laser beam shaper, configured to generate a uniform laser beam from the laser beam generated by the laser beam illumination source;
a time delay integration (TDI) image acquisition system including a movable stage designed to hold the specimen to be investigated and a bi-directional row-shiftable CCD array of a CCD camera system, wherein the movable stage and the bi-directional row-shiftable CCD array are synchronized in their operation to acquire an image of the specimen to be investigated by time delay integration; and
a binning arrangement for a low resolution image conversion, the binning arrangement including a bi-directional row-shiftable CCD array and a clock which controls operation of the CCD array, wherein the CCD array and the clock are configured to perform the binning by combining the charge of two or more pixels during a readout operation.

16. The fluorescence microscope for rare cell detector of claim 15, wherein the bi-directional row-shiftable CCD array is a back-thinned CCD array.

17. The fluorescence microscope for rare cell detector of claim 15, wherein the uniform laser beam is one of a laser beam having a flat-top, square or rectangular profile.

18. The fluorescence microscope for rare cell detector of claim 15, wherein the uniform laser beam is sized to match a portion of the sample corresponding to the CCD array.

19. The fluorescence microscope for rare cell detector of claim 15, wherein over 80% of available light of the shaped beam is used of illumination.
